(19) United States
(12) Patent Application Publication
(10) Pub. No.: US 2014/0369249 A1
(43) Pub. Date: Dec. 18, 2014

(54) MULTICAST DATA TRANSMISSION FROM A WEB SERVER TO CLIENT TERMINAL DEVICES USING A WIRELESS LOCAL AREA NETWORK

(71) Applicant: TECHNOLOGIES FOR PRESENTATION, LLC, Nizhny Novgorod (RU)

(72) Inventors: Konstantin G. Mikhailov, Nizhny Novgorod (RU); Nikolay N. Mikhaylov, Nizhny Novgorod (RU); Anton S. Pavlov, Nizhny Novgorod (RU); Vladimir V. Krylov, Nizhny Novgorod (RU)

(73) Assignee: TECHNOLOGIES FOR PRESENTATION, LLC, Nizhny Novgorod (RU)

(21) Appl. No.: 14/139,511

(22) Filed: Dec. 23, 2013

(30) Foreign Application Priority Data
Jun. 14, 2013 (RU) RU2013126981

(51) Int. Cl. H04W 4/06

(52) U.S. Cl. CPC H04W 4/06
USPC 370/312

(57) ABSTRACT

A method of multicast data transmission from a web server to client terminal devices using a wireless local area network (WLAN) includes, before transmitting data from the web server, data preprocessing including data object type identification, forming of one or several logical channels in the overall bandwidth of a WLAN for each data object type, fragmentation of data objects into multiple data packets, and marking of each data packet with a header which contains at least transmission parameters. Data packets with headers are transmitted within the logical channels by data type, in a cyclic retranslation mode or by duplicating data packets and transmitting copies with delay. Data reception by client terminal devices includes identification of a logic channel for each data packet, packet redistribution among logic channels followed by integrity control of received data packets in each logic channel with error correction

### CROSS-REFERENCE TO RELATED APPLICATION

This application claims priority pursuant to 35 U.S.C. §119 to Russian application Serial No. RU2013126981, filed Jun. 14, 2013, which is hereby incorporated by reference, in its entirety.

### FIELD

The present disclosure pertains to information and telecommunication technologies and more particularly to data transmission from a network server to client terminal devices using a WLAN.

### BACKGROUND

Efficiency improvement of data transmission to the large number of client devices in the WLANs is an increasingly important problem. To this end, certain improvements in quality and efficiency of data transmission have been achieved related to multicasting or broadcasting data transmission.

For example, quality improvement of multicast data transmission has been attempted by introducing so-called quality monitoring stations into a set of receiving client devices. Such monitoring stations represent specialized client devices equipped with modules of the WLAN, using special software. Tasks for these quality monitoring stations may include quality tracking of reception of the transmitted data packet and recording of the facts of successful packets reception, such as tracking packets received with a mistake on various sites of a covered zone of the wireless network. In the process of results recording, the monitoring stations organize the feedback with a server that is carrying out multicastibroadcast data transmission and send it confirmation messages about successfully received data packets and also about the packets received with errors. If at least one of the used quality monitoring stations sends the report that some data packet was received with an error, this packet is retransmitted again.

Such quality monitoring stations are placed in broadcasting zones where the broadcast signal is the weakest and reception is the least stable, i.e., where there are high probabilities of mistakes in data reception. Thus, the described mechanism allows a multicast/broadcast node to increase reliability of data transmission.

For further example, methods of controlling parameters of data objects transmission depending on the objects' importance and usability for the receiving clients are known. This approach identifies the priorities of transmitted data objects according to the degree of their importance and depending on specified priorities, regulates a number of transmission parameters, including bit rate (at physical level), from which this or that data object will be transmitted, changes the sequence of transmission of the objects depending on their priorities, and also specifies the number of attempts of retransmission in case of unsuccessful reception for each data object separately.

Certain prior approaches may be subject to a significant shortcoming, in that data transmission is carried out by unicast connections of the receiving client devices with the data transmission server (connections of one-to-one type). Thus, feedback from clients to the server for confirmation of successfully received data packets may greatly limit the scalability of this system with respect to the number of the client devices that can be served simultaneously.

For further example, wireless transmission of content to a large number of client devices simultaneously with the use of infrastructure of WI-FT networks may include transmission of content data packets from a content server over a wireless WI-FI infrastructure, including a sequential transmission of a set of data packets to a wireless WI-FI transmitter of the content for wireless transmission. The sequential wireless data packets transmission from the mentioned set of data packets using WI-FI infrastructure includes, before the transmission of each mentioned data packet from a data set, the wireless transmitter of the content adding a header to specified data packets. The header includes a set identifier of a general purpose allowing a set of the user devices to get access to the specified data packet, thus carrying out the transmission of each data packet from the specified set with this header. A system receiver may be wirelessly receiving the specified data packets that are transmitted by the wireless transmitter of the content. During data packets transmission, the system receiver accepts at least some of the specified data packets, and transmits information about quality of data packets reception without using a WI-FI modality. Thus, at data transmission it is not required to create for each client device a separate session at WI-FI level.

Notwithstanding their advantages, prior approaches for data transmission over local area networks may be subject to certain limitations, for example less than optimal efficiency of data transmission. For example, prior approaches lack a reliable way of providing safe data transmission on to the client devices in the absence of feedback from the clients. These and other limitations of prior methods and systems may be overcome by the technology described herein.

### SUMMARY

The present technology enables more highly reliable data transmission from a web server simultaneously to a large number of various client terminal devices using WLANs, for example local area networks (LANs), including optimization of consumption of a communication resource (e.g., bandwidth) on the air interface of these networks. Web applications, meta-data accompanying these Web applications, steering instructions of Web applications, and also a multimedia content (audio and/or video) both in the form of records of the fixed length, and in the form of streams in real time may be used as data. The technology may be used for various applications, for example for telepresentations in different public forums such as conferences, seminars, symposiums, and so forth.

In an aspect, a technical result includes providing a high scalability of transmitted data on a large number of simultaneously served client terminal devices in the WLAN, for example, from several hundred, to one thousand clients served by one access point, while simultaneously providing high reliability of data transmission (e.g., almost 100%) and optimization of traffic consumption on the air interface of the WLAN.

In embodiments of the present disclosure, an identification of the type of transmitted data is carried out. Different and independent parameters of transmission are applied to different data objects. In particular, for different types of data objects, different bit rates of transmission are used and the required number of retransmissions is determined independently. Unlike prior approaches, according to the present disclosure, independently controlled logical channels are created and regulated at application level based on the independent transmission parameters. For example, particular bit rates and required number of retransmissions are applied to different types of data.

These technical properties of the subject technology may enable servicing a large number of client terminal devices using a minimum volume of elements of the network infrastructure. For example, the introduction of this technology may enable a substantial increase of the number of user devices which can be simultaneously served by one access point within a deployed wireless WI-FI network (from several tens to several hundreds and even several thousands), and as the result the smaller quantity of such access points will be required for providing a covering of the territory on which all user devices are placed. All this may enable the total reduction of the cost of communication infrastructure, and also the simplification and acceleration of procedures of its deploying. As used herein, “WI-FI” may include IEEE 802.11 Wireless Local Area Networks (WLANs).

The original problem is solved by including into the method of data transmission from web server to the client terminal devices via the WLAN, the connection of web server and the client terminal devices in the WLAN with data transmission possibility in this network, the creation in the network of a multicast group, the connection of the client terminal devices to the created multicast group, data transmission from web server in to the WLAN in multicast mode, the data reception by the client terminal devices entering into multicast group, and reproduction of the received data on the client terminal devices.

According to the technology, before data transmission from web server in the WLAN, preliminary preparation of data for the transmission is carried out. This preparation may include, at least: identification of the type of data objects (i.e., classifying data objects by predetermined types); defining one or several logical channels representing a part of the general bandwidth of the WLAN for each type of data objects in the general bandwidth of the WLAN; and performing an additional preparation of data objects for the transmission, including fragmentation of data objects into a number of data packets and marking of each data packet with a header. The header may include, at least information identifying one of the logical channels for transmission of data packets. Transmission of data packets with headers into the wireless network is carried out in the created logical channels, in the mode of cyclic retransmission of data packets or duplication of data packets and their transmission with a time lag in reference to the originals. Accordingly, the reception of data packets by the client terminal devices may include subsequent stages of processing, including identification of logical channels within which the reception of each data packet has been carried out, the redistribution of the received packets by logical channels with the subsequent control in each logical channel of the received data packets integrity. In case of integrity violation (i.e., error detection) the repeated reception is carried out. The subsequent processing may further include reconstruction of original data objects from a set of the received packets for reproduction on the client terminal devices.

As transmitted data, the content of Web applications, and/or a character set can be used, that contain the information about steering instructions of Web applications on the client terminal devices, and/or metadata of transmitted Web applications, and/or a multimedia content in the form of audio and/or video records of the fixed length and/or a stream of audio and/or video data in real time mode.

In the course of preliminary preparation of data for transmission the data object may be marked additionally with the corresponding identifier of data objects type and the unique identifier of the object.

When using as data the content of Web applications and/or metadata, during preliminary preparation of data for transmission the data objects are united additionally into a archived bundle, the hash-code for archive is computed, with the subsequent joining of a hash-code to a archive bundle as check sum. When using as data multimedia content of a fixed length, the preliminary preparation of data for transmission may include additional computation of the hash-code, with the subsequent inclusion of a hash-code to the data object as check sum.

In the course of formation of the logical channel a unique identifier may be assigned to it, for example, in the format of GUID (Globally Unique ID). For each of the channels, the transmitter specifies at least the capacitive bit rate of the logical channel. In addition, during formation of each logical channel, the transmitter creates a cyclic retransmission buffer holding data packets with headers before transmission to the network. The transmitter may place packets in the buffer in ascending order of their sequence numbers.

The header of data packet may contain additional information for control of data packets integrity and reconstruction of data objects from them. For example, the header may include the identifier of the logical channel and/or the data object identifier identifying the part of data object that the data packet belongs to, and/or a hash-code of data packet as checksum, and/or sequence number of the packet in a set of data packets composing the data object.

According to the technology, the mode of cyclic retransmission is expedient for applying to the transmission of Web applications and/or a character set, containing information about steering instructions of Web applications and/or metadata and/or multimedia content of the fixed length, while the mode of cyclic retransmission at data packets transmission is carried out without a delay between the termination of the previous cycle of data object transmission and the beginning of the subsequent cycle, with the number of such retransmissions that is equal to N, where Nε[1, T], where T—the number of retransmissions before the termination of multicasting from web server.

The mode of duplication of data packets and their transmission with a time lag in reference to the originals is expedient for using the transmission of multimedia content of real time. Thus, the value of the variables of a time lag of the packets copy transmission in reference to their originals is chosen as one not exceeding the value of the admissible deviation from the expected interval of packet sequence.

While transmission of data packets with the symbols containing information about steering instructions, into the network, the buffer control of cyclic retransmissions is carried out, when the size of the buffer is fixed, and in case of its overrun the addition of the new instruction is carried out through the removal of the earliest one, thus the new instruction is placed at the end of the instruction list available in the buffer. While buffer control of cyclic retransmissions the frequency of receipt of new packets with a character set, containing information about steering instructions and frequency of their transmission into the network are controlled additionally, providing, at least, the single-short transmission of a packet from the buffer into the network.

In the course of data packets transmission the control of channel parameters, at least, the bit rate of this channel is carried out in the created logical channels. Control of the logical channel parameters is carried out by definition of an effective bandwidth of the WLAN, and depending on the change of this parameter the bit rate of the logical channels is changed.

In case of violation of the received packets integrity in the mode of cyclic retransmission their repeated reception is carried out on the following cycle of retransmission. In case of violation of the received packets integrity in the mode of duplication of data packets and their transmission with a time lag in reference to the originals, the reconstruction of this packet is carried out by repeated reception of its copy.

While reconstruction of the initial data objects for each packet which integrity is confirmed, the data object identifier is analyzed, identifying the data object that the received packet belongs to. For each newly detected data object an accumulative buffer is created, where all correctly received packets associated with this object are placed in. When filling the buffer with a set of data packets, composing the data object, object defragmentation is carried out. When using as data the content of Web applications and/or metadata and/or multimedia content of the fixed length after object defragmentation, the collected object is checked for its integrity by a checksum of this object and in case of detection of the fact of violation of data object integrity, the accumulative buffer is completely cleared and the procedure of data packets reception, composing this object, is repeated. Placement in the buffer of correctly received packets is carried out in the sequence corresponding to their order number in a set of data packets, composing the object. Before reproduction of the received data representing metadata or Web application, their dearchiving is carried out.

The original problem is solved also by data transmission system from web server to the client terminal devices, by the WLAN that includes infrastructure of the WLAN; the web server executed with a possibility of multicast group creation in the network and data transmission from web server into the WLAN in multicast mode; and, at least, one client terminal device executed with possibility of connection to multicast group and reception of data from the WLAN and reproduction of the received data on the client terminal device. According to the technology, web-server includes one or several modules of preliminary preparation of data for transmission into the network. Those were created depending on the type of the transmitted data, which are connected with the module of formation of logical channels and retransmission organization, which is executed with possibility of formation of one or several logical channels for each type of data objects in the general bandwidth of the WLAN. Depending on the additional preparation of data objects for the transmission, that includes fragmentation of data objects on a set of data packets, marking of each data packet with the header containing, at least, information for transmission of data packets, and also depending on the organization of the mode of cyclic retransmission of data packets or duplication of data packets and transmission of their copies with a time lag in reference to the originals. The client terminal device may include the separator of logical channels executed with possibility of identification of logical channels within which the reception of data packets is carried out. The client device may also manage redistribution of the received packets by the logical channels, connected with one or several modules of integrity control, and recovery of the data created, depending on the type of transmitted data. The client device may execute the foregoing with possibility of integrity control of the received data packets and repeated reception of packets for integrity reconstruction in case of its violation, and also for reconstruction of initial data objects from a set of the received packets for reproduction on the client terminal device.

As modules of preliminary preparation of data the system contains the module of preliminary preparation of Web applications, and/or the module of preliminary preparation of steering instructions, and/or the module of preliminary preparation of metadata, and/or the module of preliminary preparation of multimedia content in the form of audio and/or video records of the fixed length and/or a stream of audio and/or video data in real time mode.

One or several modules of preliminary preparation of data are executed with possibility of additional marking of the data object with the corresponding identifier of the type of data objects and the unique identifier of the object.

When using as data the content of Web applications and/or metadata the corresponding modules of preliminary preparation of data are executed with possibility of uniting of data objects into an archive bundle, computing of hash-code for archive, with the subsequent joining of a hash-code to archive as checksum.

Web server additionally includes the module of Web applications storage and/or the module of metadata storage, and/or the module of a multimedia content storage and/or a source of a multimedia content of real time, and the related transmitting server module, and the transmitting server module is executed with possibility of data scheduling between the mentioned modules of storage of the corresponding types of data, and the corresponding modules of preliminary preparation of data for transmission. The transmitting server module is executed with the identification possibility of data objects type in the course of preliminary preparation of data for transmission, formation of steering instructions of Web applications and transmission of the created instructions into the module of preliminary preparation of steering instructions. The source of a multimedia content of real time represents the module executed with possibility of capturing of video and/or audio stream from one or several video cameras and/or from one or several microphones, respectively, of coding of captured video and/or audio stream, and providing access to the coded stream on demand of the transmitted server module. Thus the module of preliminary preparation of a multimedia content is connected with the module of storage of a multimedia content and/or with a source of multimedia content of real time via transmitting server module. When using as data the multimedia content of the fixed length, the module of preliminary preparation of a multimedia content is executed with possibility of additional computing of a hash-code, with the subsequent association of a hash-code to the data object as checksum.

The module of formation of logical channels and the organization of retransmission is executed with possibility of assignment of the unique identifier of the logical channel in the course of its formation, and also with possibility of formation of the data packets header containing additionally the information for control of integrity of data packets and reconstruction of the data object.

The module of formation of logical channels and the retransmission organization for each logical channel contains the buffer of cyclic retransmission of data objects which is executed with possibility of placement of data packets, those composing data objects, with the corresponding headers, before the transmission into the network, in the ascending order of their sequence numbers. Besides, the buffer of cyclic retransmission, is executed with possibility of fixing of the buffer size while transmission into the network of data packets with the symbols containing information about steering instructions and logic control of the buffer operation where in case of its overrun the new instruction is added by removal of the earliest one, thus the new instruction is placed at the end of the instruction list available in the buffer. The buffer of cyclic retransmissions is executed also with possibility of frequency control of the reception of new packets with a character set, containing information about steering instructions and frequency control of their transmission into the network, providing, at least, single transmission of a packet from the buffer into the network.

The module of formation of logical channels and the organization of retransmission is executed with possibility of independent control of parameters of logical channels in the course of transmission of data packets, thus control is carried out, at least, by the bit rate of logical channel. Control of parameters of the logical channel is carried out by definition of an effective bandwidth of the WLAN, and depending on the change of this parameter the bit rate of logical channels will be changed. Moreover, this module can provide the mode of cyclic retransmission while transmission of data packets without a delay between the termination of the previous cycle of transmission of the data object and the beginning of the subsequent cycle, with the number of such retransmissions that is equal to N, where Nε[1, T], where T—number of retransmissions before the termination of multicasting from web server. Besides, the module of formation of logical channels and the organization of retransmission can be executed with possibility of choice of a time lag value of the transmission of the data packets copy in reference to their originals so that it could not exceed the value of accepted deviation from the expected intervals of the packets sequence (so called tolerated jitter).

For creation within the network of the multicast group and transmission of data packets to the wireless network, web server can contain the module of multicasting control and transmitting wireless communication module, where the module of multicasting control is connected with the module of formation of logical channels and the retransmission organization, on the one hand, and with the transmitted wireless communication module on the other hand. The module of multicast control is executed with possibility of the organization of a multicast group in the WLAN with specified IP address for multicasting and the subsequent transmission of packets onto this IP address, those were received from the module of formation of logical channels and organization of retransmission of data packets. The transmitting wireless communication module is executed with possibility of data transmission into the WLAN for providing of the direct interaction of web server with all client terminal devices.

For connection to a multicast group and reception of data from the WLAN the client terminal device contains the receiving wireless communication module connected with a separator of logical channels. The separator of logical channels represents the program module carrying out the classification and redistribution of all data packets, arriving simultaneously by several different logical channels on various modules for further processing of each logical channel separately. Its input is connected with the receiving wireless communication module and its output is connected with the modules of integrity control and data reconstruction.

As modules of integrity control and data reconstruction the system contains the module of integrity control and reconstruction of Web applications, and/or the module of integrity control and reconstruction of steering instructions, and/or the module of integrity control and reconstruction of metadata, and/or the module of correctness control of the multimedia content in the form of audio and/or video records of the fixed length and/or a stream of audio and/or video data in real time mode. Modules of integrity control and reconstruction of the data transmitted in the mode of cyclic retransmission, are executed with possibility of repeated reception of packets on the following cycle of retransmission. The module of correctness control of the multimedia content transmitted in the mode of duplication of data packets and their transmission with a time lag in reference to the originals is executed with possibility of repeated reception of the copy of this packet. Besides, modules of integrity control and reconstruction of data can contain the accumulation buffers for each received data object and are executed with possibility of placement of correctly received data packets in the accumulation buffers in the sequence corresponding to their order number in a set of data packets, those composing the object.

For reconstruction of initial data objects from a set of the received packets the modules of integrity control and reconstruction of data are executed with possibility of defragmentation of the data object when filling the buffer with a complete set of correctly received data packets, those composing the object, and also of integrity control of the collected data object by its checksum, and in case of integrity violation of the data object, the removal of all data packets from the accumulation buffer and data packets repeated reception are carried out.

The client terminal device can contain additionally the internal web server executed with possibility of representation of Web applications to the user which is connected with one or several modules of integrity control and reconstruction of data.

Besides, modules of integrity control and reconstruction of Web applications and metadata are executed with possibility of dearchiving of the received data before their transmission on to the internal web server.

In related aspects, a wireless communication apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such a client device or access terminal. In other embodiments, aspects of the technology may be embodied in a network entity, such as, for example, a server, hub, modem, or relay. In some aspects, a client device and network entity may operate interactively to perform aspects of the technology as described herein. Similarly, an article of manufacture may be provided, including a computer-readable storage medium holding encoded instructions, which when executed by a processor, cause a network entity or access terminal to perform the methods and aspects of the methods as summarized above.

### BRIEF DESCRIPTION OF THE DRAWINGS

FIG. 1 is a block diagram illustrating an internal structure of a web server in a data transmission system according to the subject technology.

FIG. 2 is a block diagram illustrating an internal structure of a client terminal device in a data transmission system according to the subject technology.

FIG. 3 is a block diagram illustrating stages of data transmission by the web server according to the subject technology.

FIG. 4 is a flow diagram illustrating aspects of preliminary preparation of data for transmission according to the subject technology.

FIG. 5 is a flow diagram illustrating aspects of additional preparation of data for transmission according to the subject technology.

FIG. 6 is a flow diagram illustrating aspects of data reception by a client terminal device according the subject technology.

### DETAILED DISCLOSURE

In the present technology the method of data transmission (in particular, of the dynamic Web applications) from web server onto the large number of the client terminal devices united by the WLAN is presented. And also the system that implements this method is presented.

The distinctive feature of the present technology is that for the purpose of scalability increase of data transmission system (for example, Web applications), i.e. increases of the number of the client terminal devices working simultaneously with transmitted web application in the specified moment of time, the web server providing the specified Web application, and also all client terminal devices using this application are connected into the general WLAN, and the transmission of Web applications from web server to all client terminal devices is carried out by multicasting of the content of Web applications in this communication network with its periodic cyclic repetition.

In the other variant of the technology, the web server is connected to the access point (router) of the WLAN by wire connection, and all client terminal devices are connected in the wireless network like the previous variant. And the multicast mode is introduced in the WLAN, like previous variant of the technology.

Thus, the introduction of multicast mode of Web applications content transmission in a combination with its cyclic repetition for a long time, allows to provide highly reliable delivery of Web applications to all client terminal devices without necessity of feedback reception from these devices in the form of confirmations about delivery or other messages. Lack of feedback traffic from client terminal devices, in its turn provides independence of this decision from the number of the client terminal devices connected simultaneously to the specified WLAN, and, therefore, dividing among themselves a radio resource on the air interface of the WLAN, that is the key to high scalability of the decision according to this technology.

According to this technology, along with cyclic multicast transmission of all Web applications content, the web server is executed with the translation possibility on all connected client terminal devices by multicasting of other types of data, among which it is possible to select:
The character sets, containing information about control or steering instructions for display of Web applications (hereinafter for simplicity of the statement the term <<steering instructions>> is used). These instructions, in particular, can regulate the time order, logic and the way of display of separate elements of the transmitted Web applications on the side of client terminal devices. In the stream of transmitted steering instructions it is selected the so-called window of retransmission representing a certain subset of steering instructions from the stream. All steering instructions those coming into the frameworks of the selected window of retransmission, are cyclically repeated for the purpose of providing of their highly reliable delivery to the client terminal devices without necessity of feedback reception from these devices. When a new steering instruction gets into the stream, it gets at once to the borders of the window of retransmission and together with other instructions is cyclically retransmitted by multicasting in the WLAN, while the “oldest” by arrival time instruction, that is available within the borders of the window of retransmission, is removed from it and is not translated anymore. The effect of sliding of retransmission window along the stream of steering instructions is reached as the result, meanwhile new and new instructions get this stream on a rolling basis.

Moreover, in one of the variants of this technology, frequency of reception of new steering instructions in the stream, the size of the window of retransmission (i.e. quantity of steering instructions being simultaneously within the frameworks of the specified window of retransmission) and interval of repetition of the whole retransmission window into the WLAN will be coordinated among themselves, thus that each new instruction which has again come into the stream was repeated (retransmitted by multicasting on the air) by not less than K times till the moment when it will be replaced with the other newer steering instructions and will overrun the retransmission window (in other words, till the moment when this steering instruction will not be retransmitted any more). Here K is one of the adjustable parameters within this method and should be obligatory not less than 1. As it will be described below, in the system, according to this technology, the window of retransmission is implemented in the form of the so-called buffer of cyclic retransmission of the fixed size. Thus the size of retransmission window coincides with the size of the buffer of retransmission.
The metadata associated with transmitted Web applications represent one more type of data, transmitted by cyclic retransmission within the method according to this technology. Described metadata can represent some certain service information accompanying the transmitted Web applications, but not being a part of the content of these Web applications. The information about users of terminal client devices, and also about rules of access of these users to the content of the transmitted Web applications etc. can be the example of such metadata.

Metadata is transmitted from web server to the client terminal devices by multicasting in the WLAN. And similarly the previous cases the cyclic retransmission of metadata is applied for the purpose of providing of highly reliable delivery to all interested client terminal devices without necessity of feedback reception from them.
The multimedia content is one more type of data, transmitted from the web server to multiple client terminal devices. The multimedia content within the frameworks of this technology conditionally is divided into two big classes: the multimedia content of the fixed length (hereinafter is also called the multimedia content on demand)—it represents a certain database of audio and/or video data, for example, recorded in advance video with a soundtrack etc.; the second category is the multimedia content of real time—audio/video captured from video cameras, microphones, or streams of a television and radio broadcasting. According to the method within the frameworks of this technology, the multimedia content (both types) is transmitted also by multicasting in the WLAN. In order to provide the highly reliable delivery of multimedia content on demand in one of the variants of the technology the method of cyclic retransmission is applied.

While transmitting the multimedia content of real time in one of the variants of the technology, in order to increase the reliability of transmission the so-called method of translation “overlapping” is applied. The essence of this method is that each data packet in the transmitted stream of multimedia content is duplicated and its copy is transmitted into the WLAN with some time lag in reference to the original. Thus, it turns out that after the main data stream one more stream is transmitted into the WLAN—its copy is transmitted with a time lag in reference to the original stream. In case of incorrect reception of the next data packet from the main stream of broadcasting of the multimedia content on any of the client terminal devices (errors of reception can be, for example, as the result of radio interference on the air interface of the WLAN, or for any other reasons), this incorrect packet is reconstructed at the expense of its repeated reception from a duplicating stream of the broadcasting going afterwards with some time lag from the main stream. For the correct work of the reception system and displaying of the multimedia content of real time some certain restrictions are imposed on the value of time lag of the duplicating stream. In particular, this value of a time lag should not exceed the value of the tolerated jitter being one of the important parameters of the required quality of the service in the WLAN (QoS) for this type of the multimedia content. The term tolerated jitter is used to specify the value of the admissible deviation from the expected intervals of packets sequence. The approximate values of this parameter for different types of the multimedia content have the following forms: for streaming of video in the Internet the tolerated jitter is about 200 ms, for the content of television of high definition (HDTV) the tolerated jitter is about 200 ms, for video coded in the H.264 format the tolerated jitter is about 20 ms, for video without compression the tolerated jitter is about 10 ms.

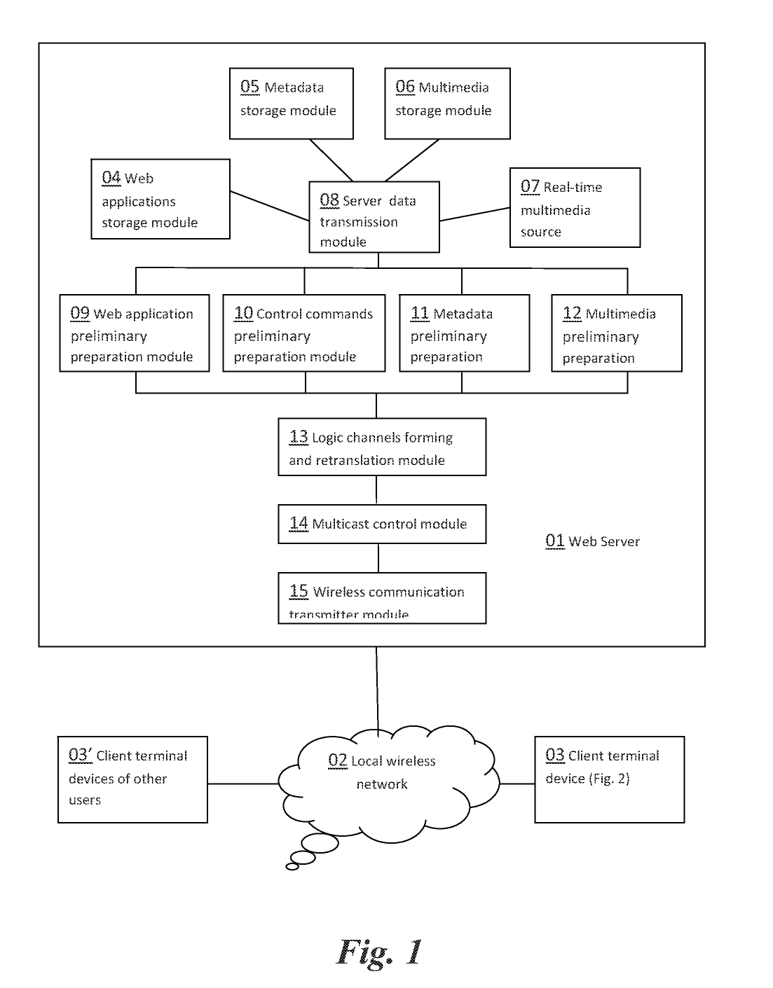

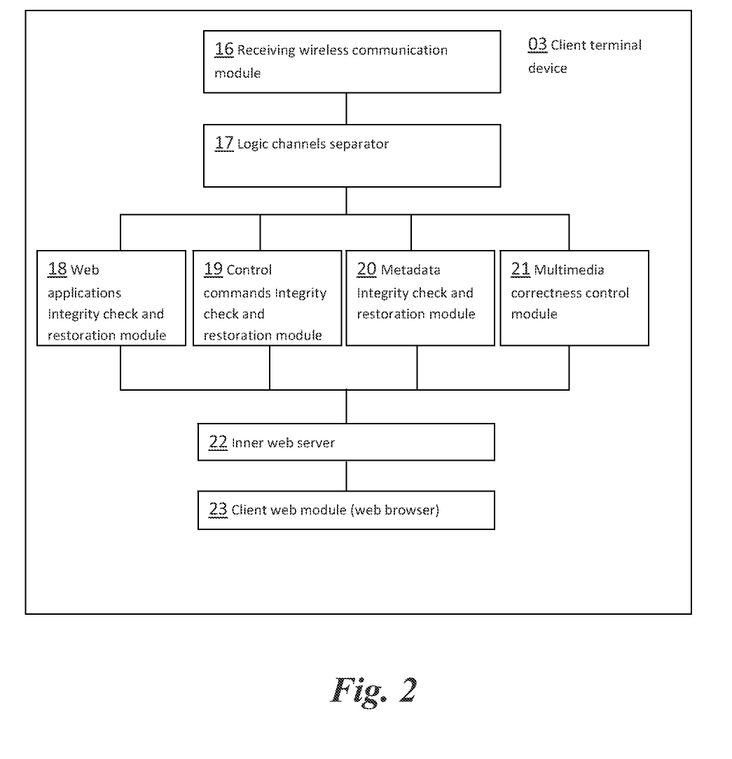

The block diagram of the system carrying out the method according to this technology, is presented on FIGS. 1 and 2.

Referring to FIGS. 1 and 2, the system of delivery of Web applications consists of the web server (module 01) connected to the WLAN (module 02), and one or several client terminal devices (modules 03) which have been also connected to this network. The web server by multicasting translates (transmits) the content of Web applications, the multimedia content, and also all necessary accompanying metadata through the WLAN onto a set of client terminal devices.

The transmitting web server (module 01) consists of data storage modules, among which are: the storage module of Web applications (module 04), the storage module of metadata (module 05), the storage module of a multimedia content on demand (of the fixed length) (module 06), and also one or several sources of the multimedia content of real time (module 07). Also the web server includes: the transmitting server module (module 08), modules of preliminary preparation of different types of the transmitted content for transportation (transmission), among which the following are separated: the module of preliminary preparation of Web applications (module 09), module of preliminary preparation of steering instructions (module 10), module of preliminary preparation of metadata (module 11) and module of preliminary preparation of the multimedia content (module 12). At the same time the web server includes the module of formation of logical channels and the organization of retransmission (module 13), the module of multicasting control (module 14), and also the transmitting wireless communication module (module 15).

The storage module of Web applications represents the module which is responsible for the storage of the content of Web applications on the web server and providing access to them. The Web application content in general can represent a set of the interconnected data objects, such as web pages in HTML format, modules of the client program code in the Java Script language, style templates for web pages in the CSS format, the data objects presented in the format of one of the languages of the description of structured data, such as XML, JSON, etc., bitmap images (drawings, photos, etc.), built in web pages in the course of their display on client terminal devices. These images can be presented in any of the formats of bitmap images representation like BMP, JPEG, PNG etc. Also it can be GIF animations. The objects of vector graphics presented, for example, in the SVG format, also can be the part of the content of Web applications.

Within the frameworks of this technology any of the known methods of data storage and providing access to them is applied in the storage module of Web applications, for example, all data objects of Web applications can be stored in the form of separate files in file system of the web server, and access to them can be carried out by standard means of access to the files, provided by the operational environment of the web server. Also for data storage of Web applications the known database control systems (DBCS) are used, such as MySQL, for example, etc.

The storage module of Web applications (module 04) provides full content of Web applications, i.e. all available data objects associated with the specified Web application, to the transmitting server module on its demand, for further transmission to their client terminal devices.

The storage module of metadata (module 05) represents the module which is responsible for storage of all metadata, associated with Web applications transmitted into the WLAN, and also for providing access to these data. The information about users of terminal client devices onto which the translation of Web applications is carried out at present moment can be the example of such metadata, also it can be the information about rules of access of all users to the content of transmitted Web applications etc.

The mentioned metadata can be presented in any of the known formats of the structured data description, for example in XML, JSON, or even in the form of the text lines containing attribute value pairs, divided by commas (so-called CSV—Comma-Separated Values) etc.

Within the frameworks of this technology in the storage module of metadata (similar to the module 04) any of the known methods of data storage and providing access to them are applied, for example, all objects of metadata can be stored in the form of separate files in file system of the web server, and access to them can be carried out by standard means of access to the files, provided by the operational environment of the web server. The known database control systems (DBCS), such as MySQL, for example are also used for storage of metadata.

The storage module of metadata provides all metadata associated with transmitted Web applications to the transmitting server module (module 08) on its demand for further transmission to their client terminal devices.

The storage module of the multimedia content (module 06) represents the module which is responsible for storage of all multimedia objects (audio and video records) and providing access to them on demand from the transmitting server module. The multimedia objects can be presented in any of the known formats of multimedia content representation, for example audio records can be presented in the formats MP3, WAV etc., videos can be coded, for example, by codecs MPEG-4 Visual, H.264, VP8, etc. by audio maintenance coded in AAC, a MP3, Vorbis and other formats.

Within the frameworks of this technology in the storage module of the multimedia content (similarly to the previous modules) any of the known methods of data storage and providing access to them are applied, for example, all audio and videos can be stored in the form of separate files in file system of the web server, and access to them can be carried out by standard means of access to the files, provided by an operational environment of the web server. The known database control systems (DBCS), such as MySQL, for example are also used for storage.

The module 07 represents a source of the multimedia content of real time. The program (or hardware-software) module which is carrying out capturing of video or audio from one or several video cameras and/or from one or several microphones respectively can be used as such source. This module carries out the coding of captured video and/or an audio stream into one of the known formats of multimedia content representation and provides access to this coded stream on demand of the transmitting server module (module 08). The multimedia stream of real time in this technology can be presented for example in the H.264 format for a video sequence, AAC for a audio feedback, multiplexed and packed, for example, in the stream container TS. Any other variants of use of the known formats of representation of the multimedia content of real time are also possible.

The transmitting server module (module 08) represents the program module which main task is the coordination of transportation of all types of data on the web server for their further translation (transmission) onto a set of client terminal devices, and also generation of steering instructions by Web applications displaying on the side of the client terminal devices.

The transmitting server module initiates transmission of Web applications, of metadata associated with them, and also both types of the multimedia content (i.e. of created in advance multimedia content (on demand), that has been stored on the web server, and also of the content of real time). Thus the module 08 carries out scheduling of these data between sources of these data (modules 04-07) and the corresponding modules of preliminary preparation of data for transmission (modules 09-12), demanding the required data objects from the corresponding modules of storage and transmitting them into the modules 09-12 for preliminary preparation for further transmission onto all client terminal devices in the WLAN.

The module of preliminary preparation of Web applications (module 09), represents the program module which main task is the transformation of the content data of transmitted Web applications into the format, that is optimal for their further translation in the WLAN.

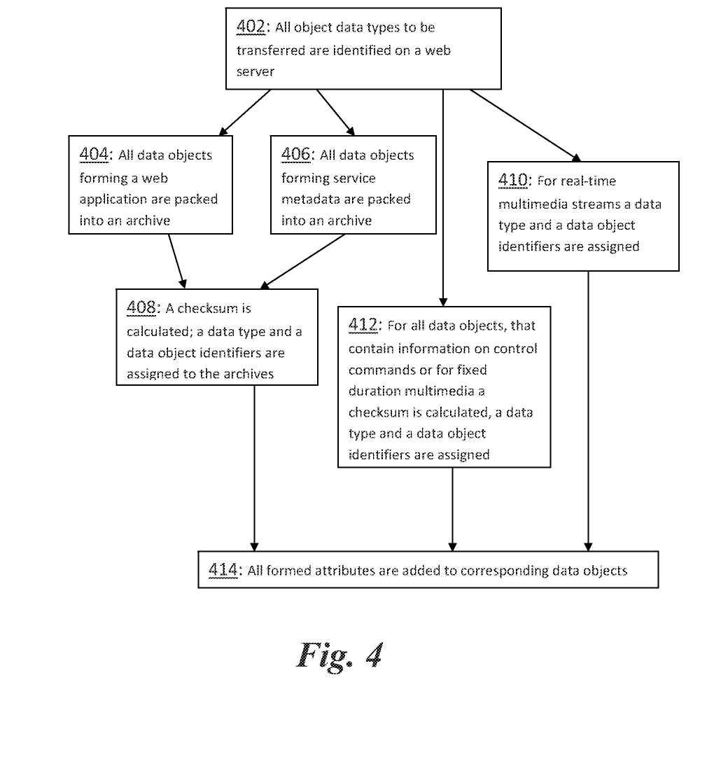

Referring to FIG. 4 illustrating aspects of preliminary preparation of data for transmission, the module 09 may run as follows—on the entrance of this module the certain set of data objects representing all content of the current transmitted Web application are sent from storage of Web applications (module 04) through the transmitting server module (module 08)—web-pages in HTML, modules of the client program code in the client scripting language Java Script, templates of style registration of web pages in the CSS format, bitmaps and vector images and other. At 402, all data object types to be transferred are identified.

At 404 and 406, all received data objects are packed into the single archive presented, for example, in ZIP, RAR, 7z or other formats using compression, and also, optionally, the superfluous information for its subsequent reconstruction in case of partial damage by transmission can be added in this archive. Thus for packing, compression and information addition for reconstruction of an archive the mechanisms known earlier are applied, those are provided for example by existing and available software tools for work with archives.

At 408 and 410, a checksum is calculated and data type and data object identifiers are assigned to archived data. After an archive bundle containing all data objects, those composing a Web application, will be received, the module of preliminary preparation of web applications generates the additional service information used further for process control of transmission of this archive. This service information, for example, allows identifying and classifying the transmitted data object in the module of formation of logical channels and the organization of retransmission (module 13) for application of the corresponding mechanism of reliable delivery on the client terminal devices. For real-time multimedia streams, a data type and data object identifiers are assigned. At 410, for all data objects that contain information on control commands or for fixed duration multimedia, a checksum is calculated and data type and data object identifiers are assigned.

Along with generation of the necessary service information, the Web application archive, is exposed to hashing. That is, on the basis of bit-to-bit representation of this archive as data object the special so-called hash-code is computed, which is necessary further as the so-called checksum on the side of the receiving client terminal modules for integrity control of the received Web application. Hashing is the known procedure and for its implementation within this technology any of the known and available program modules, which carry out such operations, can be used.

At 414, all formed attributes are added to the corresponding data objects. Further the created archive of the Web application together with the service information added to it and a hash-code (checksum) is transmitted to the exit of this module and then from it gets the module of formation of logical channels and the organization of retransmission (module 13).

The module of preliminary preparation of steering instructions (module 10) represents the program module which main task is the transformation of steering instructions by displaying of the Web applications received from the transmitting server module (module 08) into the format, that is optimal for their further transportation by the WLAN.

The stream of steering instructions addressed to the client terminal devices comes onto the entrance of this module from the transmitting server module. These instructions, in particular, can regulate a time order, logic and the way of display of separate elements of the transmitted Web applications. As a format of representation of steering instructions, any of the known formats of objects representation of the structured data can be used, for example XML, by JSON, CSV and others.

The module of preliminary preparation of steering instructions generates the additional service information necessary further for process control of commands transportation (in the module 13), like it was described above for an archive of Web applications.

Along with generation of service information, this module subjects the steering instruction to the hashing, as a result of which the hash-code of the data object representing this instruction is computed. Then the received hash-code as checksum is added to the message. And, at last, the steering instruction already together with the necessary service information and checksum are transmitted to the exit of this module and then from it comes to the module of formation of logical channels and the organization of retransmission (module 13).

The module of preliminary preparation of metadata (module 11) represents the program module which main task is the transformation of all objects of the metadata associated with the transmitted Web applications into the format, which is optimal for transportation to all client terminal devices by the WLAN.

Metadata, represent the certain service information accompanying the transmitted Web applications, but not being the part of the content of these Web applications. The information about users of terminal client devices, and also about rules of access of these users to the content of transmitted Web applications etc. can be the example of such metadata. Physically these metadata represent a certain set of data objects, serialized in any of the known formats of representation of the structured data, for example XML, JSON, CSV, etc.

The module of preliminary preparation of metadata for transportation works as follows—on the entrance of this module a certain set of objects of the metadata described above comes from the module of storage of metadata (module 05) through the transmitting server module (module 08). All received data objects are packed into the single archive bundle presented, for example, in ZIP, RAR, 7z or other formats using compression, and also, optionally, the superfluous information for its subsequent reconstruction in case of partial damage by transmission can be added to this archive. Known earlier mechanisms provided, for example, by the existing and available software tools for work with archives are used for packing, compression and information addition for reconstruction of an archive.

After an archive bundle of metadata is created, the described module will generate the additional service information necessary further for process control of transportation of the metadata archive (in the module 13), like it was described above for an archive of Web applications and steering instructions.

Along with generation of service information, this module subjects an archive of metadata to the hashing, as a result of which the hash-code of an archive of metadata is computed. Then the received hash-code as checksum is added to an archive for its integrity control while received onto the client terminal devices.

And, at last, the received archive of metadata, together with the necessary service information and checksum are transmitted to the exit of this module, from where it is transmitted into the module 13.

The module of preliminary preparation of the multimedia content (module 12) represents the program module receiving on the entrance the stream of the multimedia content of two types: video and audio clips created in advance, those received from the module of storage of the multimedia content (module 06) through the module 08, and also video and audio streams of real time, those received from the sources of the multimedia content of real time (module 07) through the module 08.

This module 12 marks each received multimedia stream with the additional service information necessary further for its identification, classification and process control of its transportation. And then transmits all multimedia streams together with the specified service information into the module 13.

The module of formation of logical channels and the organization of retransmission (module 13) represents the program module which main task is the providing of mechanisms of highly reliable delivery of Web applications and other types of data onto a large number of the client terminal devices by the WLAN.

As it was already mentioned above, the essence of mechanisms of providing highly reliable delivery, according to the present technology, consists in periodic retransmission of the transmitted data objects by multicasting in the WLAN for a long time that allows to exclude the need of feedback reception from all receiving client terminal devices, providing thus the high reliability of the content delivery. The so-called controlled logical channels of data objects transmission are formed in the general communication resource (total bandwidth) of the WLAN. Generally, several such controlled logical channels can be created and will exist simultaneously, thus dividing the general communication resource of the wireless network. The essence of the concept of the controlled logical channels and principles of their formation will be considered below.

The principle of work of this module is the following: on to the entrance of this module from the modules of preliminary preparation of data (modules 09-12) come (simultaneously) several types of data (types of data objects) those can be divided into:
the Web applications packed into archives
steering instructions, for coordination of the order and the way of Web applications displaying on the client terminal devices
the metadata associated with the transmitted Web applications, also packed into a archive
multimedia content on demand, representing the recorded audio and video clips
multimedia content of real time
any other types of data objects are also possible

All data objects coming onto the entrance of the considered module are marked with special service information (at the stage of their preliminary preparation for transmission in the modules 09-12), allowing to identify to what data types out from the provided above, this or that object belongs particularly.

For each type of data objects in the module 13 the separate controlled logical channel is formed, allowing to carry out the highly reliable transmission of all data objects of this type irrespective of the objects of all other types and to control this process of transmission also irrespective of the other types of data, choosing the most suitable algorithms (modes) of reliability providing, and also independently to control parameters of operation of this channel (in particular, by bit rate of data transmission in the logical channel), influencing thereby a number of characteristics, in particular, for the total time of receiving of the correct and complete data object by the client terminal devices under the conditions of unstable work of the radio channel on the air interface of the WLAN and high probability of errors.

Values of bit rate of data transmission in the logical channels are defined by the number of factors, in particular by the value of an available total communication resource of the wireless network, and also by the sizes of data objects. Values of these variables, for example, when using the WLANs on the basis of WI-FI technology, IEEE 802.11g are about 1-10 Mb/s.

The process of formation of controlled logical channels and transmission of data objects is carried out as follows: when next data object comes onto the entrance of the considered module, the type of data of this object is identified on the basis of the service information that accompanies the object, and if for this type the logical channel was not still created earlier, it will be created then. The unique identifier of the controlled logical channel is generated. As such identifier in one of the variants of the technology can act, for example, the well-known and everywhere used in the software globally unique identifier (GUID—Globally Unique ID). Along with the assignment of the unique identifier, the so-called buffer of cyclic retransmission of data objects in the logical channel is also created. All objects will be temporarily stored in this buffer (fragmented in the form of a set of data packets), transmitted within the specified logical channel. In one of the variants of the technology the size of the buffer of cyclic retransmission is dynamically changed depending on the total quantity of data packets which need the cyclic retransmission.

Along with the buffer formation, the operating mode of mechanisms providing reliable transmission is chosen (or data transmission mode with cyclic retransmission or transmission mode <<overlapping>> are used, which were described above) and all key parameters of the controlled logical channel are configured (in particular, the value of bit rate of data transmission in the logical channel) depending on the type of the data objects transmitted in the logical channel, and also, depending on the current situation in the environment of the WLAN (for example, depending on the general workload of the network, on the level of radio channel disturbance etc.).

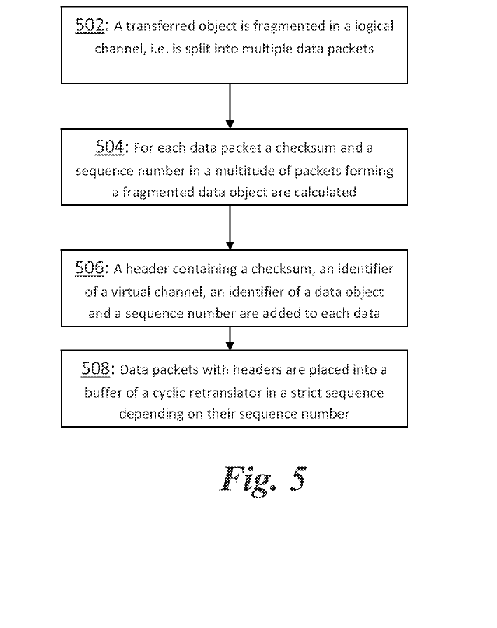

As soon as the formation of infrastructure of the created controlled logical channel is completed, the transmitted data object is subjected to the additional preparation for transmission within this channel. Referring to FIG. 5 illustrating aspects of additional preparation of data for transmission, at 502, a transferred object is fragmented in a logical channel, i.e., split into multiple data packets. For this purpose this object is considered simply as the data store of binary data (a set of bytes which are required to be transmitted to the channel) and are also fragmented, i.e. they are broken into a defined set of identical parts, fragments or data packets (though in general, these fragments can be of different size). At 504, for each data packet, a checksum and a sequence number in a multitude of packets forming a fragmented data object are calculated.

Then, at 506, the header consisting of the defined set of attributes of data is added to each data packet. One of such attributes is the sequence number in the general set of the packets composing data object. In one of the variants of the present technology the offset value of the bit position of this fragment (packet) concerning the beginning of the body of a data object can act as such attribute. This attribute will be used further for defragmentation, that is, for reconstruction of integral data objects from a set of fragments on the side of reception.

Also the numerical value, corresponding to the total number of data packets those composing the considered data object is added into structure of the header of the packet.

Each data packet is subjected to hashing, as the result of which the hash-code of this fragment is generated which will be used as checksum for control of integrity and correctness of this fragment at its reception on the client terminal devices.

As soon as the hash-code for the packet is generated, it will be added into the header of data packet. Besides, the unique identifier of the logical channel is also added into the header. After the header of data packet is created, it will be added to this packet (i.e. the packet is marked with this header). Then data packet is added into the buffer of cyclic retransmission. All the rest data packets composing a data object, are processed similarly, all of them are also added into the buffer of cyclic retransmission of this logical channel, moreover they are added in the strict sequence, according to the ascendancy of their sequence numbers. Thus, as the result, all body of the data object appears to be placed in the buffer of cyclic retransmission in the form of some set of packets.

At 508, after the whole data object is placed in the buffer of cyclic retransmission, its transmission into the WLAN within the logical channel will start, in the way that all packets containing fragments of the transmitted data object are consistently one by one transmitted to the exit of the considered module and then in the module of multicasting control (module 14). Data packets with headers are placed into a buffer of a cyclic retranslator in a strict sequence depending on their sequence number. As soon as the total content of the buffer of cyclic retransmission of this logical channel is transmitted into the module of multicasting control, the repeated transmission of the contents of this buffer will start, again, from the first packet and further consistently all packets containing in the buffer, one by one. In one of the variants of the technology such cyclic transmission of the total contents of the buffer is repeated many times for a long time until the stop command for translation from the transmitting server module (module 08) comes into the considered module 13. Generally the quantity of cycles of retransmission should be not less than one, and restriction as to the extra quantity can be defined by the general time till the termination of multicast data transmission by the web server.

The time lag (interval) between cycles of transmission of data objects is equal in this technology to zero. That is immediately after the termination of transmission of the last data packet from the buffer of cyclic retransmission, the retransmission of the total contents of this buffer starts on the spot.

In one of the variants of the technology at formation of logical channels in the module 13 the fixed values of bit rates of data transmission are specified. Thereby the work of each virtual channel is provided only within the frameworks of the general communication resources of the wireless network of its designated amount. In the other variant of this technology the use of the mechanisms of dynamic adaptive control of bit rates in all logical channels on the basis of the current context of the situation of data transmission is possible. This current context can be defined by a set of various factors, including—by the priorities of transmission of different types of data objects, by the general value of variables of communication resources (an effective bandwidth) in the WLAN at present time, and also by the conditions arising in the radio channel on the air interface of the wireless network and by other factors.

It should be noted that the variant with dynamic adaptive control of logical channels enables more flexible and optimal translation of data in the constantly changing conditions.

At the subsequent arrival onto the entrance of the module 13 of data objects of the same type, as the first object described above which transportation has already began in the earlier created logical channel, all these again arriving objects are subjected to the similar procedure of fragmentation described above, formations of packages, and then they are added into the buffer of cyclic retransmission of this logical channel, transmitting cyclically after the data objects which already exist in this buffer.

It should be noted that the cyclic retransmission described above is recommended to be applied in this technology for the transmission of Web applications, of the metadata associated with these applications, of the character sets containing information about steering instructions for Web applications on the client terminal devices, and also of the multimedia content (audio and/or records) of the fixed length. For streams of the multimedia content of real time it is recommended to use the special mode (mechanism) of translation which is called <<overlapping>>, providing the increase of reliability of delivery of this type of data objects which essence is in detail described above at the description of the multimedia content of real time as data type.

Transmission of steering instructions in the logical channel is carried out according to the described mechanism of cyclic retransmission with the only difference that the additional logic forming on the basis of this buffer, the so-called sliding window of retransmission is imposed on the behavior of the buffer of cyclic retransmission besides its basic logic described above. The mechanism of the sliding window of retransmission is described above in detail at the description of steering instructions as one of the types of data objects. As it was mentioned above, the size of the buffer of cyclic retransmission (that is, the maximum quantity of data packets which it can contain) is fixed. When the buffer is full of the arriving data packets, the reception of the next packet (containing steering instruction) causes the removal of the earliest received packet (the “oldest” one) from the buffer, all other data packets in it are displaced on one position to the beginning of the buffer, and again received packet is added in the buffer end, on the last position.

Thus, the streams of data packets from the all controlled logical channel come to the exit of the module of formation of logical channels and the organization of retransmission (module 13) and as soon as available these packets are transmitted from the exit of the module 13 to the entrance of the module 14.

The module of multicasting control (module 14), represents the program module which main task is the organization of multicasting of data from the web server to all interested client terminal devices by the WLAN.

As it was already mentioned above, the stream of the transmitted data packets from all logical channels comes onto the entrance of this module. The considered module will organize a group of multicasting in the WLAN with the certain specified Internet Protocol (IP) address for multicasting. And then transmits all received data packets to this IP address, that is, actually in the specified multicast group. Thus all data packets coming simultaneously from several various controlled logical channels, are entered on single general queue as soon as available on the entrance, and then, from this queue are transmitted to the module exit, previously, being supplied with the IP address of target multicast group and all other service information necessary for the formation of a full-rate IP packet. The mechanism of formation of IP packets is widely known in the field of telecommunications and is applied now in all communication systems based on TCP/IP protocols stack. IP packets containing the transmitted data packets are transmitted to the module 15 from the exit of the module of multicasting control.

The transmitting wireless communication module (module 15) represents the hardware-software device for data exchange in the WLAN. This device provides the direct interaction of the web server with all client terminal devices. The type of the transmitting wireless communication module and its main characteristics depend on the type of the used WLAN. So, for example, if WI-FI standard network (e.g., IEEE 802.11 a/b/g/n/ac/ad) is used as the wireless network, then standard WI-FI module of any manufacturer can be used as the transmitting wireless communication module.

IP packets from the module of multicasting control come onto the entrance of this module, and from the exit of this module these packets are transmitted into the WLAN, into the multicast group organized inside (module 14).

The WLAN (module 2) represents the local network supporting wireless data transmission by TCP/IP protocols. As an example as it was already mentioned above, in this technology the wireless network according to WI-FI standard can be used. However along with WI-FI in this technology other technologies of the organization of the WLANs can be used.

As it was shown on the drawing FIG. 1, the client terminal device may include the following modules:
the receiving wireless communication module (module 16),
separator of logical channels (module 17),
control module of integrity and reconstruction of Web applications (module 18)
control module of integrity and reconstruction of steering instructions (module 19)
control module of integrity and reconstruction of metadata (module 20)
control module of the correctness of multimedia content (module 21)
internal web server (module 22)
client web module (module 23)

The receiving wireless communication module (module 16) represents the hardware-software device for data exchange in the WLAN (like module 15). Also as well as the module 15, type of the receiving wireless communication module and its main characteristics depend on the type of the used WLAN. And in case of using of the wireless networks on the basis of WI-FI technology, as the receiving wireless communication module the existing WI-FI module of any manufacturer can be used.

IP packets with the data, distributed within the frameworks of the specified multicast group come onto the entrance of the receiving wireless communication module. These IP packets will be retransmitted by this module into the module 17.

The separator of logical channels (module 17) represents the program module carrying out the classification and redistribution of all data packets, arriving simultaneously by several different logical channels on various modules for further processing of each logical channel separately (modules 18-21).

The stream of IP packets comes onto the separator entrance from the receiving wireless communication module. Thus each received IP packet at first is subjected to the preliminary processing according to TCP/IP protocols stack, as a result of this processing the transmitted data packet is taken out of the IP-packet (belonging to one of the logical channels). Then the attribute of the service data from the acquired packet is analyzed, that represents the unique identifier of the logical channel, it shows, within what of the logical channels involved this packet is transmitted. And according to the value of the identifier the packet is retransmitted into one of the following modules for further processing:
all packets transmitted within the logical channel organized for translation of the data objects containing Web applications are sent to the control module of integrity and reconstruction of Web applications (module 18);
all packets transmitted within the logical channel organized for translation of the data objects containing steering instructions of displaying of Web applications are sent to the control module of integrity and reconstruction of steering instructions (module 19);
all packets transmitted within the logical channel organized for translation of the data objects containing metadata, associated with transmitted Web applications are sent to the control module of integrity and reconstruction of metadata (module 20);
all packets containing transmitted streams of multimedia data are sent to the control module of the correctness of the multimedia content (module 21).

After that the function of the separator of logical channels comes to the end, and the above mentioned modules 18-21 start to act.

The control module of integrity and reconstruction of Web applications (module 18) represents the program module which main task is providing of the integrity and reconstruction in the original form of all data objects composing the content of Web applications, received by this client terminal device.

This module works as follows: the stream of the packets containing fragments of data objects, representing archived bundles of Web applications comes onto its entrance from the separator of logical channels. At the first stage the accumulation of the received data packets and control of their integrity are carried out. After all packets are accumulated, and their integrity is confirmed, the second stage will start—data object defragmentation (i.e. the assembly of the initial data object from the packets composing it). On completion of the defragmentation procedure, already held data object representing an archive of Web application is subjected to the procedure of integrity control and in case of the positive result the second stage of processing comes to the end. The third stage starts where the basic data—all data objects, composing Web application content are reconstructed out from the received data object, that is, Web application archive.

The procedure of accumulation of data packets and control of their integrity in detail looks as follows: in the considered module the special accumulative buffers will be created (for each received data object there will be the separate buffer) where all received fragments are placed. In one of the variants of the technology the sizes of the accumulative buffers dynamically change depending on the total quantity of data packets representing the certain data object.

When the next data packet is received the procedure of its integrity control is carried out. It is carried out as follows: the received packet is subjected to hashing, as the result of which the hash-code of this packet is computed. This hash-code is then compared with the checksum—the same hash-code generated earlier on the transmitting side. The checksum is added to the received data packet and becomes the part of its header. If in the result of the comparison the computed hash-code precisely coincides with the checksum, the processor may determine that this fragment has been received correctly and store its integrity. Otherwise it is determined that the data packet has been received with an error (the so-called “broken” packet).

All data packets forming the object which were received correctly are saved into an accumulative buffer. With this said, in one of current technology variations a placement of packets in the buffer according to their actual place inside the initial data object is possible. Accordingly, the positions which correspond with erroneous fragments stay vacant, i.e. no data packets are placed there. Erroneous data packets are then discarded.

After a client terminal device had received all the packets which form the current data object, only those of them which had been received correctly and are consistent end up in the accumulative buffer. The rest of the data packets will be received during the following iterations of a cyclic retranslation process of a web server. At the same time, the concerned module will receive the missing data fragments (received earlier with an error), and if the fragments are correct, they will fill the vacant positions in the accumulative buffer. The data packets which end up incorrect on a second try will be received on a third, fourth try etc.

In the end, during one or several retranslations all the data packets that form the data object end up being correct and are located in the accumulative buffer.

After a defragmentation procedure the assembled data object is hashed and the obtained hash code is compared to the checksum of the initial object. If the calculated hash code complies fully with the checksum then the data object is consistent and has been received correctly. If the data integrity check shows that it has been breached, then all the data packets received earlier (for the current data object) are deleted from the accumulative buffer and a repeated reception and accumulation of all data packages already being on corresponding retranslation cycles is carried out.

The data object received this way represents an archived or compressed web application. The next step is uncompressing (unpacking) of the web application in the current module. Any known program components for working with data archives, depending on an archiving method of the transmitter, can be used for the operation.

As a result, a set of data objects which form a web application content comes out of the concerned integrity control and restoration module. All the content is then received on the inner web server (Module 22).

Control module of integrity and reconstruction of steering instructions (Module 19) is a program module the main task of which is integrity assuring and restoration of all web application steering instructions, received by a client terminal device from the web server, in their initial form.

The integrity control mechanism in the current module is similar to Module 18 —correction of erroneous data packets via their repeated reception during the following cyclic retranslation iterations is also applied here. After the correctness of the following received package containing a command (i.e. a steering instruction) had been confirmed, said steering instruction (or control command) is transferred to the output of the concerned module and then to the inner web server. It is worth mentioning, that, in the current module, all control commands are processed and transferred to the output in a strict succession to their reception at the input as data packets.

Metadata integrity and control module (Module 20) is a program module the main task of which is integrity assuring and restoration of all data object forming metadata associated with web applications in their initial form.

The principle of operation of current module is similar to Module 18. A stream of packets containing fragments of a data object representing a metadata archive are received at the current module's input from a logical channel separator. Processing of the packets, same as in Module 18, consists of fragment accumulation and their integrity control, defragmentation of the data object with following restoration of initial metadata from an archive.

As a result, the received metadata is transferred to the current module's output and then to the inner web server (module 22).

Multimedia content correctness control module (Module 21) is a program module the main task of which is reception of multimedia content of both types (audio and video of fixed duration, as well as real time streams).

A stream of packets containing data objects in the form of multimedia content is received at the input of the current module from the logical channel separator.

The process of data packet accumulation and integrity control with the following defragmentation similar to the one described in module 18 is implemented for audio and video of fixed duration. As a result, initial video and audio files are transferred to the output of the concerned module and are then received on the inner web server (module 22).

For real time multimedia streams translated via overlapping a simpler scheme of integrity control is used. Each following multimedia data packet received is checked for correctness (by comparing its hash code with a checksum, as before), if the packet is correct it is immediately transferred to the output of the current module and from there to the inner web server. If a received packet is incorrect, an attempt of its reception from a following duplex stream is made and, in case of its successful reception the packet is transferred to Module 22. If the packet in the duplex stream is also broken, i.e. erroneous, it is simply discarded and the next real time multimedia stream packet is awaited.

The inner web server (Module 22) is a program module that imitates a web application server for a client web module (Module 23). On the one part, all the data required for its correct operation is received from Modules 18-21 at the input of the inner web server in form of web applications, metadata, multimedia content if it is necessary to be presented to client during the functioning of web applications, and also control commands (steering instructions) that coordinate the functioning of web applications. On the other part, requests from the client web module (Module 23) formed by it in the process of interaction of an end user with web applications are received at the input of the current web module.

The inner web server's task is to ensure web applications functioning on a client web module in the same way as common World Wide Web servers work.

Client web module (module 23) is a common web browser installed on a client terminal device. It grants access for end users to web applications received on the inner web server. In the process of its work Module 23 closely interacts with the inner web server by sending user requests and receiving required content regulated by web application functioning logic on the inner web server.

Practical Use of the Technology

An example of current technology's practical use is a smart presentation system in WLANs. Said system is applied when organizing different public meetings which require lecturer's speech before an audience—conferences, seminars, forums, symposiums and so forth. The technology may enable a translation of lecturers' presentations in real time directly to attendants' personal mobile devices (tablets, smartphones, laptops and netbooks) via WLAN.

The smart presentation system, implemented on the basis of this technology, is organized the following way. In the location of public meetings a WLAN is organized based on a Wi-Fi technology (usually, IEEE 802.11 g/n/ac standards are used, but not limited to). In a developed prototype of the smart presentation system the network infrastructure equipment is used (one Wi-Fi access point manufactured by D-Link) working with IEEE 802.11 g standard in a frequency range of 2.4 GHz. A so called presentation server, that is, a web server component according to current technology (Module 01 on a FIG. 1 picture) is linked into the wireless local communications network. A hardware platform containing the presentations server (web server) is a basic desktop PC. The presentations server is equipped with a hardware communication module of a local wireless Wi-Fi network or WLAN (Module 15 of the current technology) and specialized software for translation of presentations to client terminal devices which is implemented according to the given technology. The software implements program modules 04 to 14 (see FIG. 1).

Web applications translated by current system are dynamic presentations such as Microsoft PowerPoint presentations with prior conversion to web format (a system of data objects consisting of HTML pages, images, CSS style sheet modules, user script modules based on JavaScript language etc.). 10 of above mentioned applications with an average size of 1 megabyte are used in a developed smart presentation prototype. These presentations are stored on a web server (Module 04).

Metadata associated with transferred web applications are also stored on a web server. In the given system this metadata represents information on all registered users (audience and lecturers), on system access rights for each user and a number of other parameters used by the system during presentation (web application) display, including a complete list of all data objects that these presentations contain. Metadata are stored on the web server in a metadata storage module (Module 05). Total metadata size is about 20 kB.

The web server also contains a 15 megabyte video file. The video file is encoded using H.264 codec, its related audio stream is encoded using AAC. The video file is kept in a multimedia content storage module (Module 06).

During operation of the smart presentation web application control commands (or steering instructions) are formed on a web server and are represented as data objects in form of a text symbol set (in XML format). The size of such data objects may vary from 200 bytes to 1024 bytes. Maximum control command generation frequency is 10 commands per second.

The web server carries out multicasting of presentations (web applications), metadata associated with them, web application control commands and the abovementioned video file in the WLAN to all client terminal devices connected to a multicast group. When transferring data objects a cyclic retranslation mode is used on a web server according to the current technology.

Personal mobile devices—tablet PC's and Apple iOS/Google Android based smartphones (27 units total) with previously installed client software serve as client terminal devices in the current system. The abovementioned client software implements program modules 17 to 23 according to structure scheme on FIG. 1.

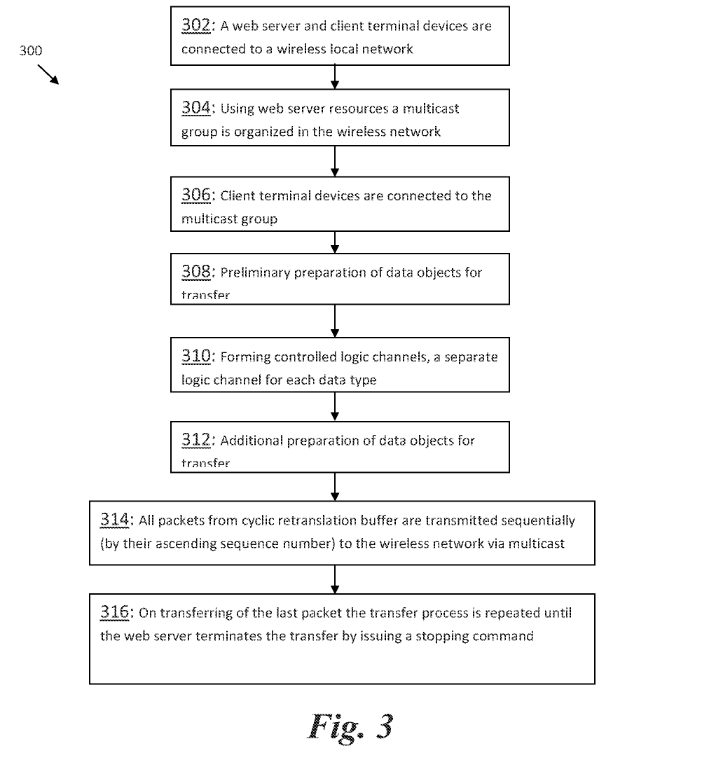

Referring to FIG. 3 illustrating stages of data transmission by the web server and continuing to refer to FIGS. 1-2, the functioning prototype implements the current technology the following way:

Initially, at 302, a web server and client terminal devices are connected to a wireless network. Upon the start of the presentation (web application) transfer to the web server, the server immediately prepares all the web application content, all required metadata and the video file (associated with the application) for transfer. During the preparation for transfer a transmitting server module (Module 08) receives all the required data objects from their respective storage modules (Modules 04 to 06), identifies the type of the objects and redirect them to the relevant preparation modules (Modules 09 to 12). After that, a preparation of all data objects is carried out, according to current technology method.

At the same time, at 304, a multicast group is organized in the WLAN and all 27 client terminal devices are connected to it at 306. The multicast organization procedure in networks and the connection of client devices to the multicast are well known processes and are regulated by proper standards, so they won't be reviewed in the context of the current technology.

Upon finishing the preliminary preparation of abovementioned data objects at 308, the data objects are transferred to a logic channel formation and retranslation organization module where, at 310, a separate controlled logic channel is formed for each data type and all objects of this type are additionally processed at 312 and transferred within current logic channel. There are 4 logic channels created within current prototype: one for web applications transfer, one for metadata transfer, one for transfer of data objects containing control commands (steering instructions) and one for transfer of the video file. For each logic channel a unique identifier is given upon its creation in the form of GUID (Globally Unique Identifier); also, data transmission bit rate is set for each channel. At the same time:
Bit rate of 3 Mbit/s is set for web application oriented logic channel
Bit rate of 1 Mbit/s is set for metadata oriented logic channel
Bit rate of 1 Mbit/s is set for control command oriented logic channel
Bit rate of 5 Mbit/s is set for multimedia content (of fixed length) oriented logic channel

Summary communication resource (bandwidth) of a wireless Wi-Fi network used in data transmission equals 10 Mbit/sec.

All data objects received within logic channels undergo additional preparation according to current technology. During the additional preparation the objects are fragmented, i.e. broken into separate fragments, so called data packets. The size of each data packets in the given prototype is 1024 bytes. If the data capacity assigned to a packet is less than this number (for example, when transmitting symbols, containing control commands with the size varying from 200 bytes to 1024 bytes) the size of a data packet is set based on actual data capacity.

Cyclic retranslation infrastructures are created in each logical channel. Buffer size is changed dynamically based on the amount of data packets prepared for transfer for each logical channel excluding the one carrying out control command transmission. For the logical channel that carries out control command transmission (symbols, containing descriptions of control commands) the retranslation buffer size is fixed. In the current prototype the size of the buffer equals 250 commands.

At 314, data object transmission in all logical channels is carried out using a cyclic retranslation mode. And there is no delay between separate retranslation cycles. At 316, upon transferring of the last packet the transfer process is repeated until the web server terminates the transfer by issuing a stopping command.

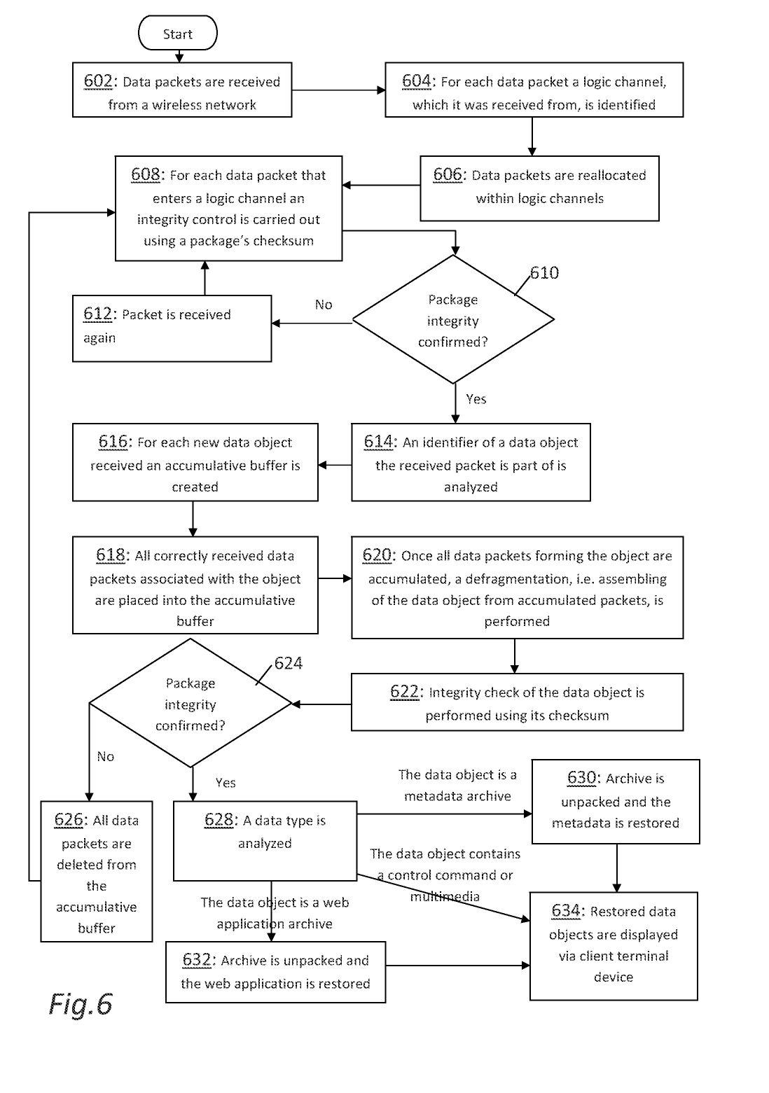

Data packet reception and their following processing on all client terminal devices in the current prototype are carried out in full compliance with the present technology. FIG. 6 illustrates aspects of data reception by a client terminal device according the subject technology. Initially, at 602, data packets are received from a wireless network. At 604, the client device identifies a logic channel for each data packet. At 606, the client device reallocates and collects the data packets within the identified logic channels, in a memory. In addition, at 608 and 610, for each data packet that is allocated to a logic channel, the client device performs integrity control using a package's checksum. If the integrity check fails, the packet may be received again at 612.

For each data packet that passes the integrity check, the client device, at 614, analyzes the data packet to identify a data object, for example, using an associated identifier. At 616, for each new object detected, the client device may create an accumulative buffer. Accordingly, at 618, all correctly received data packets identified as part of the data object are placed in the accumulative buffer. At 620, once all data packets forming the object are accumulated, the client device may defragment the data object. That is, the client may assemble the data object from the accumulated data packets.

At 622 and 624, the client device may perform an integrity check of the data object using an associated checksum. If the check fails, all data packets may be deleted, and the object requested again. For each object that passes the integrity check, the client device may determine a data type, at 628, and take an action depending on the data type. For example, if an archive bundle containing web application is detected, the client may, at 632, unpack the archive and restore the web application. If the object is an archive bundle containing metadata, the client may, at 630, unpack the archive and restore the metadata. After that at 634 all restored data objects are sent to inner web server for display to users. In an aspect, each client terminal device, upon receiving all required content of the presentation (and accumulating it within inner web server), starts to display it to users via an integrated web browser (client web-module 23, using terminology of the current technology).

Once user is switching presentation slides, the server generates proper control commands (i.e. steering instructions) which are also transmitted to all client devices within the command logical channel organized for them. As a result, slide switching also takes place on all user devices simultaneously with the lecturer.

Similarly, if the lecturer starts an animation on the next slide during the presentation, a corresponding control command is generated which is then transmitted to all client devices and starts the animation on the same slide on all devices. Thus, control commands allow synchronizing the presentation's current state on all client devices with its state on the server in real time.

Also, the transmission of current position coordinates of a so called electronic pointer, which is a certain mark, indicating a particular area on a current presentation slide and letting a lecturer to focus attention of the audience is fulfilled with the help of a control command mechanism.

The advantage of the current technology is in providing a high scalability of the developed solution based on the amount of client terminal devices supported simultaneously in a WLAN (from a few hundreds to more than a thousand clients supported by an access point) with providing a high reliability of data transmission (close to 100%) and optimizing traffic consumption on an air interface of a local communications network at the same time.

These technical properties of the present technology, as a result, ensure coverage of a large number of client terminal devices with using minimal number of network infrastructure elements. For example, implementation of current technology leads to a real increase of a number of user devices supported simultaneously by an access point in a Wi-Fi wireless network (from a few hundreds to, potentially, a few thousands). As a result, a lesser number of such access points will be needed to ensure coverage of the territory where all user devices are allocated. This all leads to considerable reduction of communication infrastructure costs and to its easier and quicker deployment. In the upshot, the technical result gained with the help of the current technology will bring a good economic effect.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a non-transitory computer-readable medium. Non-transitory computer-readable media includes storage media. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-Ray™ disc wherein disks usually hold magnetically encoded data, while discs hold optically encoded data. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of data transmission, comprising:
preparing, by a server, data for multicasting from the server to client terminal devices via a wireless local area network (WLAN) including identifying data objects in the data by data object type and configuring one or more separate logic channels in a bandwidth of the WLAN for each data object type;
preparing, by the server, the data objects for multicasting by fragmenting each of the data objects into multiple data packets, and providing each of the data packets with a header containing corresponding transmission parameters;
multicasting the data packets via the WLAN with the headers using the separate logic channels of the WLAN by cyclic retranslation mode of data packets or by duplication and transmission of copies with delay.

2. The method according to claim 1, wherein the data comprises web application content or symbol sets, containing information on web application control commands on client terminal devices or metadata of transferred web applications.

3. The method according to claim 2, wherein the data further comprises multimedia content, such as data objects selected from audio or video of fixed length or audio or video data streams transmitted in real time.

4. The method according to claim 1, further comprising marking data the objects prior to their transmission with a certain identifier of data object type and a unique object identifier.

5. The method according to claim 2, further comprising buffering the data objects, calculating hash code for each of the data objects with following hash code addition to a buffer as a checksum, for data objects comprising the web application content and/or metadata.

6. The method according to claim 3, further comprising calculating a hash code and adding hash code to a data object as a checksum during preparation of data transmission, for data object comprising multimedia content of fixed length serves.

7. The method according to claim 1, further comprising providing a unique identifier to each of the one or more logic channels.

8. The method according to claim 7, wherein the unique identifier comprises a Globally Unique Identifier (GUID).

9. The method according to claim 1, further comprising setting of a different bit rate corresponding to each of the one or more logic channels.

10. The method according to claim 1, further comprising configuring a cyclic retranslation channel for allocating data packets before their transmission to the WLAN, wherein packets are allocated in a buffer according to ascending sequence number.

11. The method according to claim 1, further comprising including additional information for data packet integrity control and data object restoration in each header of the data packets.

12. The method according to claim 11, further comprising including, in each header of the data packets, at least one of: a logic channel identifier, identifier of the data object of which the current data packet is part of, data packet hash code serving as a checksum, data packet sequence number in a data packet set, and total number of data packages forming the data object.

13. The method according to claim 2, further comprising applying a cyclic retranslation mode for transmission of any one of: web applications of symbols containing information about control commands, metadata, or multimedia content of fixed length.

14. The method according to claim 1, further comprising applying the cyclic retranslation mode when transmitting data packets without delay between the end of previous data object transmission cycle and the beginning of a following cycle with a number of such retranslations equaling N, where Nε[1, T], where T means a number of retranslation before the end of a multicast from a server.

15. The method according to claim 3, further comprising use of data packet duplication mode and their delayed transmission in comparison to their originals for real time multimedia content transmission.

16. The method according to claim 1, further comprising choosing a delay time of transmission of packet copies in comparison to transmission of their originals not exceeding the value of allowable deviation from estimated packet sequence periodicity when carrying out duplicated data packet transmission.

17. The method according to claim 10, further comprising controlling a cyclic retranslation buffer when transmitting data packets containing control command information to the network, when the size of the buffer is fixed and, in case of buffer overflow, a new command is added by deleting the earliest command in the buffer and adding the new command to the end of a command list in the buffer.

18. The method according to claim 17, further comprising additional control of reception frequency of new packets with symbol sets, containing control commands and frequency of their transmission to the network when controlling a cyclic retranslation buffer, ensuring at least a single packet translation from the buffer to the network.

19. The method according to claim 1, further comprising controlling channel parameters in formed logic channels during data packet transmission with controlling of transmission bit rate.

20. The method according to claim 19, further comprising controlling logic channel parameters by defining an effective bandwidth of a WLAN and, based on this parameter's variation, changing logic channels' bit rates accordingly.

21. A method of data reception, comprising:
receiving, by a client device, multicast data from a server via a wireless local area network (WLAN), wherein data objects in the data are identified by data object type and the data is multicast via separate logic channels in a bandwidth of the WLAN for each data object type, and the data objects are fragmented into multiple data packets providing with a header containing corresponding transmission parameters;
detecting a logic channel identifier for each data packet;
allocating the data packets between the logic channels followed by error correction of received data packets in each logic channel, wherein in case of a packet error, the client device repeats receiving each of the data packets for which an error is detected; and
restoring the data objects from the data packets on the client device.

22. The method according to claim 21, further comprising repeating receiving of packets on a next retranslation cycle in case of packet error in cyclic retranslation mode.

23. The method according to claim 21, further comprising restoring a packet by receiving its copy in case of packet error received in the mode of packet duplication and transmission with delay.

24. The method according to claim 21, further comprising, when restoring the data object for each error-free packet, analyzing an identifier of a data object which includes said packet, accumulating each data object in a buffer wherein all correctly received packets associated with the data object are placed, and, when the buffer is filled with data forming the complete object, assembling the data object.

25. The method according to claim 24, further comprising checking an integrity of the assembled object using a checksum and, upon discovering an integrity breach, clearing the buffer repeating the receiving the data packets forming the object.

26. The method according to claim 24, further comprising placing correctly received packets in a buffer in accordance to their sequence number in the multitude of data packets forming the object.

27. The method according to claim 21, further comprising unpacking received data which represent metadata or web applications prior to their playback.

28. An apparatus for data transmission, comprising a processor coupled to a memory, the memory holding instructions that when executed by the processor, cause the apparatus to perform:
preparing data for multicasting from a server to client terminal devices via a wireless local area network (WLAN), including identifying data objects in the data by data object type and configuring one or more separate logic channels in a bandwidth of the WLAN for each data object type;
preparing the data objects for multicasting by fragmenting each of the data objects into multiple data packets, and providing each of the data packets with a header containing corresponding transmission parameters;
multicasting the data packets via the WLAN with the headers using the separate logic channels of the WLAN by cyclic retranslation mode of data packets or by duplication and transmission of copies with delay.

29. The apparatus according to claim 28, wherein the memory holds further instructions for marking data the objects prior to their transmission with a certain identifier of data object type and a unique object identifier.

30. The apparatus according to claim 28, wherein the memory holds further instructions for buffering the data objects, calculating hash code for each of the data objects with following hash code addition to a buffer as a checksum.

31. The apparatus according to claim 28, wherein the memory holds further instructions for calculating a hash code and adding hash code to a data object as a checksum during preparation of data transmission.

32. The apparatus according to claim 28, wherein the memory holds further instructions for setting of a different bit rate corresponding to each of the one or more logic channels.

33. The apparatus according to claim 28, wherein the memory holds further instructions for configuring a cyclic retranslation channel for allocating data packets before their transmission to the WLAN, wherein packets are allocated in a buffer according to ascending sequence number.

34. The apparatus according to claim 28, wherein the memory holds further instructions for including additional information for data packet integrity control and data object restoration in each header of the data packets.

35. The apparatus according to claim 28, wherein the memory holds further instructions for including, in each header of the data packets, at least one of: a logic channel identifier, identifier of the data object of which the current data packet is part of, data packet hash code serving as a checksum, data packet sequence number in a data packet set, and total number of data packages forming the data object.

36. The apparatus according to claim 28, wherein the memory holds further instructions for applying the cyclic retranslation mode when transmitting data packets without delay between the end of previous data object transmission cycle and the beginning of a following cycle with a number of such retranslations equaling N, where Nε[1, T], where T means a number of retranslation before the end of a multicast from a server.

37. The apparatus according to claim 28, wherein the memory holds further instructions for choosing a delay time of transmission of packet copies in comparison to transmission of their originals not exceeding the value of allowable deviation from estimated packet sequence periodicity when carrying out duplicated data packet transmission.

38. The apparatus according to claim 28, wherein the memory holds further instructions for controlling channel parameters in formed logic channels during data packet transmission with controlling of transmission bit rate.

39. The apparatus according to claim 38, wherein the memory holds further instructions for controlling logic channel parameters by defining an effective bandwidth of a WLAN and, based on this parameter's variation, changing logic channels' bit rates accordingly.

40. An apparatus for data reception, comprising a processor coupled to a memory, the memory holding instructions that when executed by the processor, cause the apparatus to perform:
receiving multicast data from a server via a wireless local area network (WLAN), wherein data objects in the data are identified by data object type and the data is multicast via separate logic channels in a bandwidth of the WLAN for each data object type, and the data objects are fragmented into multiple data packets providing with a header containing corresponding transmission parameters;
detecting a logic channel identifier for each data packet;
allocating the data packets between the logic channels followed by error correction of received data packets in each logic channel, wherein in case of a packet error, the apparatus repeats receiving each of the data packets for which an error is detected; and
restoring the data objects from the data packets in the memory.

41. The apparatus according to claim 40, wherein the memory holds further instructions for repeating receiving of packets on a next retranslation cycle in case of packet error in cyclic retranslation mode.

42. The apparatus according to claim 40, wherein the memory holds further instructions for restoring a packet by receiving its copy in case of packet error received in the mode of packet duplication and transmission with delay.

43. The apparatus according to claim 40, wherein the memory holds further instructions for, when restoring the data object for each error-free packet, analyzing an identifier of a data object which includes said packet, accumulating each data object in a buffer wherein all correctly received packets associated with the data object are placed, and, when the buffer is filled with data forming the complete object, assembling the data object.

44. The apparatus according to claim 40, wherein the memory holds further instructions for checking an integrity of the assembled object using a checksum and, upon discovering an integrity breach, clearing the buffer repeating the receiving the data packets forming the object.

45. The apparatus according to claim 40, wherein the memory holds further instructions for placing correctly received packets in a buffer in accordance to their sequence number in the multitude of data packets forming the object.

46. The apparatus according to claim 40, wherein the memory holds further instructions for unpacking received data which represent metadata or web applications prior to their playback.
